(19) United States
(12) Patent Application Publication
(10) Pub. No.: US 2010/0326827 A1
(43) Pub. Date: Dec. 30, 2010

(54) METHOD AND APPARATUS FOR ISOLATING AND PURIFYING BIO-MOLECULES

(76) Inventors: Shang-Chi LIN, Tainan County (TW); Chia-Chen LIN, Tainan County (TW)

Correspondence Address: BIRCH STEWART KOLASCH & BIRCH, PO BOX 747, FALLS CHURCH, VA, 22040-0747, US

(21) Appl. No.: 12/490,514

(22) Filed: Jun. 24, 2009

(51) Int. Cl. G01N 27/26

(52) U.S. Cl. 204/461; 204/613

(57) ABSTRACT

Electrophoresis systems, apparatus, and methods for isolating or purifying a bio-molecule are provided. The method includes using an electrophoresis apparatus for isolating or purifying a bio-molecule, wherein the electrophoresis apparatus includes: a separation tube including a first section for containing buffer and a second section including an electrophoresis gel, and a collection tube including a solid phase, wherein the solid phase fully covers the cross-sectional area of the collection tube, and the collection tube is detachably connected to an end adjacent to the second section of the separation tube.

### BACKGROUND OF THE INVENTION

1. Field of the Invention

The present invention relates to the field of molecular biology and biotechnology, and in particular relates to methods and devices for purifying small nucleic acid molecules.

2. Description of the Related Art

The nucleic acid is used in various fields in various forms. For example, in the field of recombinant nucleic acid technology, the nucleic acid is required to be used in the form of a probe, a genomic nucleic acid, and a plasmid nucleic acid. In many cases, the nucleic acid can be obtained in a very small amount, and a complicated and time-consuming operation is required for isolation and purification. This frequently time-consuming and complicated operation is easy to cause a loss of nucleic acid. In the case where a sample containing two or more bio-molecules, it would be more complicated and inconvenient to isolate and purify each one.

With recent discoveries related to microRNA and siRNA molecules, both of which have a powerful affect on the expression of genes, research in the identification, detection, and use of small RNAs has expanded. The molecules, which are generally short, are used to silence the expression of specific genes at the post-transcriptional level by an RNA interference (RNAi) pathway. MicroRNAs, which are small regulatory RNA molecules, have been shown to regulate target gene expression in various organisms. siRNA and mature microRNA molecules generally range between about 15 and 30 nucleotides in length. Other types of small RNAs include small nuclear RNAs (snRNAs) and small nucleolar RNAs (snoRNAs), both of which are involved in mRNA and rRNA processing. tRNAs (about 70-90 bases), and 5S rRNA (about 120 bases), are both involved in protein translation.

Meanwhile, research of small RNAs focus on isolating or purifying small nucleic acid molecules, in the size of 15 to 200 nucleotides, with high efficiency.

Methods for purifying small RNAs have been disclosed. One method for purifying small RNAs is chemical extraction employing concentrated chaotropic salts in combination with phenol or phenol-chloroform. This method is used to dissolve or precipitate proteins, allowing the protein-free phase to be separated by centrifugation.

Another method for purifying small RNAs relies on selectively immobilizing RNAs on a solid surface (generally glass fiber) such that the proteins and debris can be washed away and the RNA can be eluted in an aqueous solution. This solid-phase type method relies on high salt or salt and alcohol to decrease the solubility of the RNAs for water and increase the affinity of the RNAs for the solid support used. The use of glass (silica) as a solid support has been shown to work for large RNAs, but is generally not considered useful for isolating small RNAs unless special procedures are employed involving both lysate purification as well as the use of two separate RNA binding and elution steps. The mirVana™ miRNA isolation procedure relies on a phenol-chloroform lysate purification step prior to RNA purification. This method also relies on the use of two silica binding membranes, with the first membrane used to bind the large RNA molecules and the second membrane used to bind the small RNA molecules.

Additionally, gel electrophoresis is also used to isolate and purify small RNAs. Individual components of RNA samples are separated into individual bands, which can be visualized by UV light. Methods for collecting sample bands from an electrophoresis gel include cutting out the identified band of interest from the gel, and recovering the sample component of interest from the excised gel to catch the sample component of interest.

However, the conventional methods for purifying small RNAs do not quickly and efficiently isolate and purify the specific small RNA due to the undesirable dilution of a sample component and contamination of large RNA. FIGS. 1a-1b illustrate the distribution of a RNA fragment after purification using commercial product Ambion mirVana™ miRNA Isolation kit (FIG. 1a) and Ambion flashPAGE (FIG. 1b). Referring to FIGS. 1a-1b, the large RNA fragment in the sample, about 40-150 nt, was not removed by the commercial product, and it results in the contamination of the large RNA.

Thus, simple and efficient bio-molecule purification methods and devices that mitigate the previously mentioned problems are required.

### BRIEF SUMMARY OF THE INVENTION

The invention provides an electrophoresis apparatus for isolating or purifying a bio-molecule comprising: (a) a separation tube comprising a first section for containing buffer and a second section including an electrophoresis gel, and (b) a collection tube comprising a solid phase, wherein the solid phase fully covers the cross-sectional area of the collection tube, and the collection tube is detachably connected to an end adjacent to the second section of the separation tube.

The invention further provides a method for purifying or isolating bio-molecules, comprising: (1) providing the electrophoresis apparatus of the invention; (2) loading a sample comprising at least one bio-molecule to the first section of the separation tube; (3) applying an electric field by implementing at least one anode and at least one cathode to drive the at least one bio-molecule into the solid phase, wherein the electrophoresis apparatus is located between the at least one anode and at least one cathode; (4) detaching the collection tube from the separation tube, and (5) purifying the at least one bio-molecule isolated in the collection tube.

The invention further provides a kit comprising an electrophoresis apparatus of the invention; a running buffer; at least one elution or purification buffer; and an user instruction.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIGS. 1a-1b illustrate the distribution of an RNA fragment after purification using commercial products;

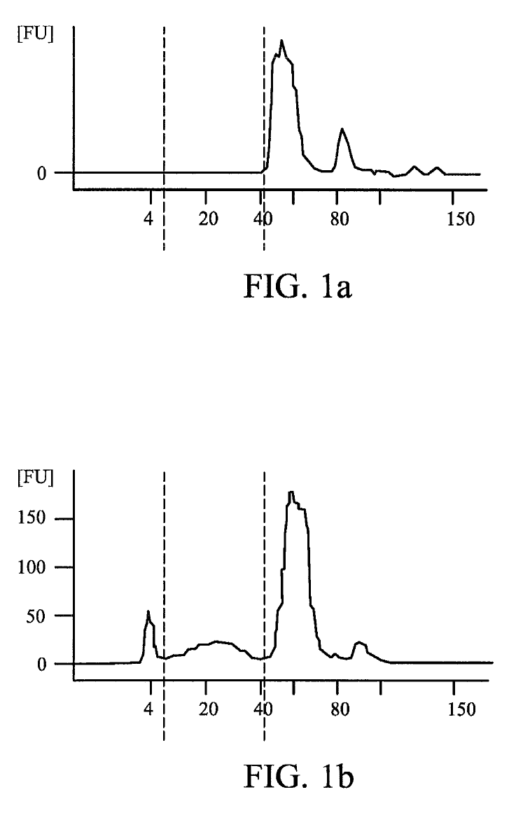

FIGS. 2a-2b illustrate an embodiment of the electrophoresis apparatus used in the methods of the invention;

FIG. 3 shows a side view and front view of an electrophoresis apparatus of the invention, respectively;

FIG. 4 illustrates the distribution of an oligonucleotide fragment before and after purification using the method of the invention;

FIGS. 5a-5b illustrate the distribution of miRNA before and after separation, respectively;

FIG. 6 illustrates the distribution of miRNA before and after separation, and

FIG. 7 illustrates the distribution of an oligonucleotide fragment before and after purification using the method of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

The invention provides an electrophoresis apparatus for isolating or purifying a bio-molecule, wherein the electrophoresis gel comprises: (a) a separation tube comprising a first section for containing buffer and a second section including an electrophoresis gel, and (b) a collection tube comprising a solid phase, wherein the solid phase fully covers the cross-sectional area of the collection tube, and the collection tube is detachably connected to an end adjacent to the second section of the separation tube.

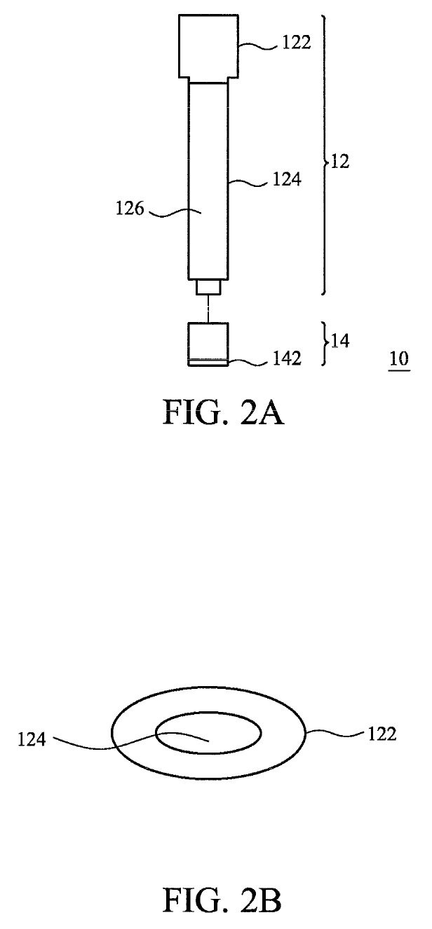

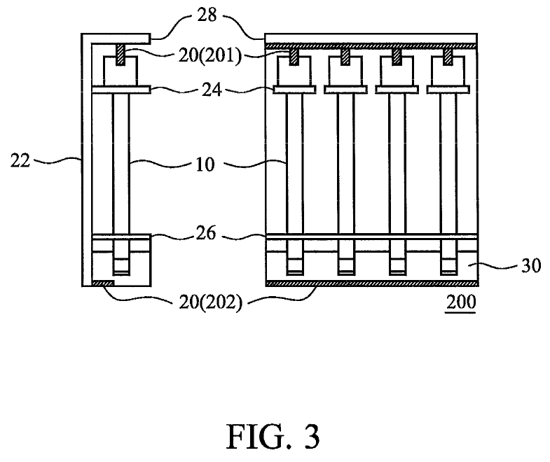

FIG. 2A illustrates one embodiment of the electrophoresis apparatus used in the methods of the invention. FIG. 2B is a cross-sectional view of an electrophoresis apparatus, and FIG. 3 shows a front view and a side view of the electrophoresis tank with the electrophoresis apparatus of FIG. 2.

Referring to FIG. 2A, electrophoresis apparatus 10 includes a separation tube 12 and a collection tube 14. The separation tube 12 includes a first section 122 for containing buffer, such as an electrophoresis running buffer, and a second section 124 including an electrophoresis gel 126. The collection tube 14 includes a solid phase 142, wherein the solid phase 142 fully covers the cross-sectional area of the collection tube 12. The electrophoresis gel 126 is located between the first section 122 and the collection tube 14. The term “electrophoresis gel” as used herein, refers to a variety of gels that may be used in the technique of gel electrophoresis and includes gels formed by a variety of gel matrix materials, including polyacrylamide, agarose, polyacrylamide-agarose composites, and the like. One skilled in the art would select an appropriate gel depending upon the at least one bio-molecule. The length, width, and height of the separation tube 12 and electrophoresis gel 126 are not limited. In one embodiment, the separation tube has a diameter of 0.1 to 2 cm, preferably 0.5 to 1 cm. The electrophoresis gel 126 has a length of 0.5 to 20 cm, preferably 3 to 10 cm.

Note that the solid phase 142 is set in the collection tube 14, in particular, the solid phase 142 is spread on the bottom surface of the collection tube 14 and fully covers the cross-sectional area of the collection tube 14. The shape of the collection tube 14 includes, but is not limited to, a cylindrical, a taper, a cube, a cuboid, or a like thereof.

FIG. 2B is a vertical view of the first section 122. Referring to FIG. 2B, the first section 122 may not be closed so that the samples can be loaded to the electrophoresis gel 126, and the electrode can be installed in the first section 122.

The term “solid phase”, as used herein, refers to a bead, a membrane, or a filter. The solid phase is capable of absorbing nucleic acid or peptides in a solution. The solid phase can be in the form of beads, membranes, or filters. If the solid phase is in the form of beads (bead-type solid phase), means for holding the beads is optionally included. Such means include but are not limited to a supporting membrane or supporting filter having a pore size smaller than the diameter of the bead. If the solid phase is in the form of a membrane (membrane-type solid phase) or filter (filter-type solid phase), the solid phase membrane or solid phase filter is directly employed to absorb bio-molecules. In some embodiments, the bead-type solid phase can be completely or partially spherical or cylindrical. However, the bead is not limited to any particular three-dimensional shape. Examples of the bead include agarose, silica, cellulose or latex. The diameter of the bead can be about 25 to 500 μm, preferably from 25 μm to 100 μm. The supporting membrane or filter is a microporous structure having a pore size smaller than the bead. In some embodiment, the solid phase is a membrane-type or filter-type solid phase, and fully covers the cross-sectional area of the collection tube. To minimize the hand-on time of purification, the selection rules of membrane or filter acting as supporter or solid phase in the colletion tube are according to the water-extruding flow rate. The definition of the “flow rate” as used herein to define the pore size is the time for an amount of water to extrude through the membrane or filter in a column when centrifugation is applied. The flow rate attributed by the pore size of the membrane or filter can be between about 0.005 and about 1 mL/min/mm² under between 2000×g and 10000×g centrifugation. In one embodiment, the flow rate is 0.0177˜0.15 mL/min/mm².

The solid phase is preferably cationic. In one embodiment, the solid phase can be a “cationic solid phase”. The term “cationic solid phase” as used herein, refers to the solid phase with a positive charge by any known method. Examples of the positive charge method include, but are not limited to, a chemical modification (e.g., primary, secondary, tertiary, or quaternary amino group). In one embodiment, the cationic solid phase can be a cation membrane having K⁺, Na⁺, Li⁺, Ca²⁺, Mg²⁺, Ba²⁺, or Sr²⁺ on the surface of the membrane. The cationic solid phase can be a commercial product, such as Vivapure Ion Exchange with functional groups of quaternary ammonium (Vivapure ion exchange Column Q) or diethylamine (Vivapure ion exchange Column D). In one embodiment, the beads may be a plurality of quaternary amine agarose beads. In another embodiment, the beads may be a plurality of tertiary amine cellulose beads. The membrane or filter acts as a platform or surface to absorb nucleic acids and/or to facilitate the absorption of nucleic acids onto the membrane. Examples of membranes for use with the invention include nylon, PVDF, cellulose and the like. In one embodiment, the filter may be a tertiary or quaternary amine filter.

The collection tube 14 of apparatus 10 is detachable, so that it can be replaced by another collection tube after an electrophoresis process. In one embodiment, two bio-molecules in one sample are isolated by the electrophoresis apparatus of the invention. During the electrophoresis process, a first bio-molecule traveling from the first section 122 of the separation tube 12 to the collection tube 14, is adsorbed in a solid phase. After the first solid phase is replaced with second solid phase by substituting another collection tube, an additional electrophoresis process is carried out to obtain a second bio-molecule.

The length, width, and height of apparatus 10 are not limited. In one embodiment, the length of apparatus 10 can range from 0.5 cm to 20 cm, and the width of apparatus 10 can range from 0.1 cm to 2 cm.

FIG. 3 shows a side view and a front view of an electrophoresis kit. Referring to FIG. 3, the electrophoresis kit 200 includes a body 22, a plurality of electrophoresis apparatus 10 fixed by column bolts 24 and fixed rings 26 in the body 22, two electrodes 201 and 202, and a liftable cover 28. The bottom of electrophoresis apparatus 10 is soaked in a buffer 30. The buffer can be an electrophoresis running buffer.

In one embodiment, the electrode 201 is a cathode, and the electrode 202 is an anode. In another embodiment, the electrophoresis kit 200 may optionally include current converter to change the electric field of the electrodes 201 and 202. The electrodes 201 and 202 are preferably soaked in a buffer to conduct electricity, when an electrophoresis process is carried out.

The present invention further provides a novel method for purifying a bio-molecule. In one aspect, the method of the invention includes the following:

(1) providing or obtaining an electrophoresis apparatus comprising (a) a separation tube comprising a first section for containing buffer and a second section including an electrophoresis gel, and (b) a collection tube comprising a solid phase, wherein the solid phase fully covers the cross-sectional area of the collection tube, and the collection tube is detachably connected to an end adjacent to the second section of the separation tube.

(2) loading a sample comprising at least one bio-molecule to the electrophoresis gel.

(3) applying an electric field by implementing at least one anode and at least one cathode to drive the at least one bio-molecule into the solid phase, wherein the electrophoresis apparatus is located between the at least one anode and at least one cathode, and the solid phase is soaked in water or a buffer.

(4) detaching the collection tube from the separation tube.

(5) purifying the at least one bio-molecule isolated in the collection tube. The purification includes but is not limited to using high salt, chaotropic salt or strong cationic detergent solution to elute the bio-molecule from the solid phase, adding an alcohol solution such as ethanol or isopropanol to the eluate, applying the solution mixture to a solid support such as a silica-based solid support, and eluting the bio-molecule from the solid support.

The location of the bio-molecules can be monitored by detecting UV light illumination or fluorescence or monitoring the location of an electrophoresis indicator, e.g. xylene cyanol dye or bromophenol blue dye during application of the electric field.

The term “sample”, as used herein, refers to a mixture of a plurality of unique molecular species which can be separated using gel electrophoresis. By way of example only, a sample may be a mixture of nucleic acids, a mixture of oligonucleotides, a mixture of DNAs, a mixture of RNAs, or combinations thereof. In addition, by way of example only, a sample may be a mixture of amino acids, a mixture of peptides, a mixture of proteins, or combinations thereof. For example, a sample may be a mixture of a molecular species and a plurality of contaminants.

The term “bio-molecule”, as used herein, refers to a nucleic acid, protein, a peptide, and other macromolecules. A nucleic acid includes DNAs, RNAs, oligonucleotides, recombinant DNA molecules, and fragments and analogs thereof. Nucleic acid sequences may be derived from genomic DNAs, RNAs, mitochondrial nucleic acids, chloroplast nucleic acids and other organelles with separate genetic materials.

As used herein, the term “nucleic acid molecule” refers to the phosphate ester polymeric form of ribonucleosides or deoxyribonucleosides or any phosphoester analogues thereof, such as phosphorothioates and thioesters, in either single stranded form, or a double-stranded helix. Double stranded DNA-DNA, DNA-RNA, and RNA-RNA helices are possible. The term nucleic acid molecules, and in particular DNA or RNA molecules, refers only to the primary and secondary structure of the molecules, and does not limit it to any particular tertiary forms. Thus, this term includes double-stranded DNA found, inter alia, in linear or circular DNA molecules (e.g., restriction fragments), plasmids, and chromosomes. In discussing the structure of particular double-stranded DNA molecules, sequences may be disclosed herein according to the normal convention of 5′ to 3′ direction sequences along the nontranscribed strand of DNAs.

The term “peptide” refers to an oligomer in which the monomers are amino acids (usually alpha-amino acids) joined together through amide bonds. Peptides are two or more amino acid monomers long, but more often are between 5 to 10 amino acid monomers long and can be even longer, i.e. up to 20 amino acids or more, although peptides longer than 20 amino acids are more likely to be called “polypeptides”. The term “protein” is well known in the art and usually refers to a very large polypeptide, or set of associated homologous or heterologous polypeptides, that has some biological function. For purposes of the present invention the terms “peptide”, “polypeptide”, and “protein” are largely interchangeable as all three types can be attached to an association peptide by similar methodology and so are collectively referred to as “polypeptides”.

Samples of the invention can be loaded to the first section 122 of the separation tube 12 and located on the electrophoresis gel 126. When an electric field is applied in the invention, bio-molecules travel from cathodes to anodes in the electrophoresis gel, and then adhere to a solid phase. One skilled in the art may select proper methods and agents to separate the bio-molecules from the solid phase and obtain the bio-molecules. In one embodiment, if the bio-molecule is nucleic acid, it can be eluted from the solid phase using high-molarity salt (e.g., 3 M sodium acetate, 4 M NaCl), SDS, high-molarity chaotropic salt (e.g. guanidine salt) by centrifugation, and thereby isolated.

### EXAMPLE

### Example 1

### Fabrication of the Electrophoresis Apparatus of the Invention

A 10% polyacrylamid gel mixture (10% acrylamide:bis=29:1, 1× TBE, 0.07% Ammonium persulfate, and 0.05% TEMED) was poured into a separation tube with a diameter of 6 mm and length of 10 cm. After the polyacrylamide gel mixture was solidified, a collection tube with a length of 1 cm was linked to the polyacrylamide gel, wherein the tube contained 50 μl of Q Sepharose (Amersham Biosciences, cat#17-0510-10) and was filled with a 1× TBE buffer to remove the air bubbles in the tube.

### Example 2

### Oligonucleotide Isolation

A mixture of 2 μl loading dye (0.2% Bromophenol blue dye, 0.2% Xylene cyanol dye, 80% glycerol) and 10 μl of Cy5-labeled oligonucleotide mixture (1 μM 20 nt Cy5-labeled oligonucleotide, 1 μM 60 nt Cy5-labeled oligonucleotide) was added to the polyacrylamid gel (electrophoresis gel) and then electrophoresis was carried out at 250 V until most of the Bromophenol blue dye (electrophoresis indicator) was out of the gel.

After electrophoresis, the collection tube containing the Q Sepharose was removed from the separation tube and placed on a 2-ml centrifuge tube. 150 μl of RNase-free water was added to the collection tube, and then centrifuged at 6000×g for 30 seconds, This step was repeated twice. The collection tube was placed on a new 2-ml centrifuge tube. Further, 50 μl of 3M sodium acetate (pH 5.2) was added to the collection tube and then centrifuged at 6000×g for 30 seconds to obtain a flow-through solution containing oligonucleotides. This step also was repeated twice.

Next, the flow-through solution was mixed with 233 μl of 100% EtOH and 3 mg silica gels (Fluka, cat#60734), and then centrifuged at 10000×g for 1 minute to retrieve the silica gels. The retrieved silica gel was washed two times with 500 μl of 100% EtOH and then centrifuged at 1000×g for 1 minute to remove the supernatant. The mixture of washed silica gels and 500 μl of 75% EtOH was added to Ultrafree-MC (PVDF 0.65 μm, Millipore, cat#UFC30DV00) and then centrifuged at 10000×g for 1 minute to remove the flow-through. Finally, the silica gels was washed three times by 20 μl of RNase-free water for eluting the oligonucleotides, and then the eluate containing oligonucleotides was collected by centrifugation of 10000×g for 1 minutes. The eluate containing oligonucleotides was separated by electrophoresis at 250 V for 30 minutes.

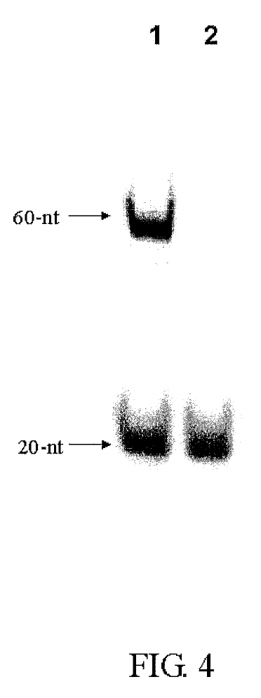

Referring to FIG. 4, after electrophoresis (lane 2), only 20 nt oligonucleotide existed in the obtained solution.

### Example 3

### Mature miRNA Isolation

6×10⁶ HepG2 cells were mixed with 1 ml of TRIzol (Invitrogen, cat#15596-018). After standing at room temperature for 5 minutes, 200 μl of 1-bromo-3-chloropropane was added and mixed for 15 seconds. After standing at room temperature for 5 minutes, the mixture was centrifuged at 12000 g for 15 minutes at 4° C. to obtain a supernatant. The supernatant was mixed with ⅓ times volume of 100% EtOH, and then the resulting mixture was added to a Qiagen RNeasy mini column to obtain a flow-through solution by centrifugation of 13000 rpm for 1 minute. The flow-through was divided into two groups. Each group was mixed with 10 μl of linear acrylamide (Ambion, cat#AM9520) and two times the volume of 100% EtOH. After standing for 30 minute at −20° C., the mixture was centrifuged with 16100×g for 20 minute at 4° C. to remove the supernatant and obtain pellets. The pellets were washed with 100 μl of 85% EtOH and dried for 3 minutes. The dried pellets were dissolved in 5 μl of RNase-free water and mixed with 1 μl of an RNase inhibitor and 4 μl of a loading dye (0.2% Bromophenol blue dye, 0.2% Xylene cyanol dye, 80% glycerol) to obtain an RNA solution. The RNA solution was separated by using the electrophoresis apparatus of Example 1 and electrophoresis at 250 V until most of the Bromophenol blue dye was out of the gel.

After electrophoresis, the collection tube containing the Q Sepharose was detached from the gel column and placed on a 2-ml centrifuge tube. 150 μl of RNase-free water was added to the collection tube, and then centrifuged at 6000×g for 30 seconds. This step was repeated twice. The collection tube was placed on a new 2-ml centrifuge tube. Further, 50 μl of an RLT buffer (Qiagen, cat#74104) was added to the collection tube and then centrifuged at 6000×g for 30 seconds to obtain a flow-through solution containing oligonucleotides. This step was repeated twice.

The flow-through solution containing RNA was mixed with 233 μl of 100% EtOH and 3 mg of silica gels (Fluka, cat#60734) and then centrifuged at 6000×g for 30 seconds to remove supernatants and obtain the silica gels. The silica gels was washed two times with 500 μl of 100% EtOH and then centrifuged at 10000×g for 1 minute to remove the supernatants. Subsequently, the silica gels was mixed with 200 μl of 80% EtOH and then the mixture was added to Ultrafree-MC (PVDF 0.65 Mm, Millipore, cat#UFC30DV00). After centrifuging the Ultrafree-MC at 10000×g for 1 minute, the RNA adsorbed on silica gels was dissolved by 20 μl of an RNase-free water to obtain a solution containing RNA. The solution containing RNA was collected and analyzed by Small RNA assay kit and Agilent 2100 Bioanalyzer.

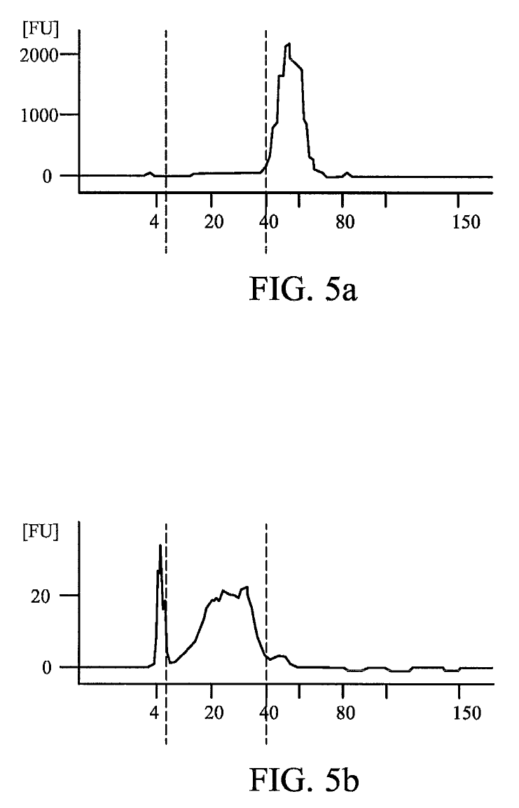

FIGS. 5a-5b illustrate the distribution of miRNA before and after separation, respectively. Referring to FIG. 5a, before separation, the RNA fragments between 40 and 80 nt was the main ingredients in the sample. However, after separation, the RNA fragment exceeding 40 nt was removed and the desired RNA fragments (mature miRNA), RNA fragments of 4-40 nt, were obtained as shown in FIG. 5b.

### Example 4

### Separation of miRNA Using Beads

A 8% polyacrylamid gel mixture (8% acrylamide:bis=29:1, 1× TBE, 0.07% Ammonium persulfate, and 0.05% TEMED) was poured into a separation tube with a diameter of 6 mm and length of 10 cm. The gel solution was stood for 30-60 min until the gel was solidified. After the polyacrylamide gel mixture was solidified, an Ultra free-MC column (0.65 μm, Millipore #UFC30DV25) containing 150 μl of 33 v/v % Microgranular Cellulose DE-52 (Whatman, cat#4057-050) and fullfilled with 1× TBE buffer was linked to the polyacrylamide gel.

6×10⁶ HepG2 cells per tube were mixed with 350 μl of lysis buffer (7.2M Urea; 2% CHAPS (3-[(3-Cholamidopropyl)dimethylammonio]-1-propanesulfonate); 2 mM DTT (dithiothreitol); 0.001% Xylene cyanol dye; 0.001% Bromophenol blue dye). The cell lysate was added into Favorgen filter column (Favorgen#FABRK001-1) and the column was centrifuged at 13000 rpm for 30 seconds to decrease the viscosity of the cell lysate. 100 μl of cell lysate was added to the electrophoresis apparatus within 10 min after cell lysis and separated the bio-molecules by electrophoresis at 3 mA until most of the Xylene cyanol dye traveled to a line which has a distance of 2.4 cm from the bottom of the gel column.

After electrophoresis, the Ultra free-MC column with the DE-52 beads was detached from the gel column and placed on a 2-ml centrifuge tube. 300 μl of RNase-free water was added to the Ultra free-MC column, and then centrifuged at 2000×g for 30 seconds. This step was repeated twice. The Ultra free-MC column was placed on a new 2-ml centrifuge tube. Further, 50 μl of an FARB buffer (Favorgen#FABRK001-1) was added to the Ultra free-MC column, incubated for 3 min, and then centrifuged at 2000×g for 30 seconds to obtain a flow-through solution containing oligonucleotides. This step was repeated twice.

The flow-through solution containing RNA was mixed with 233 μl of 100% EtOH, The mixture was added to a Favorgen micro column (with glass fiber filter; provided by Favorgen Biotech Corp.) and centrifuged at 10000×g for 30 seconds. The Favorgen micro column were washed two times with 500 μl of Wash 2 buffer (Favorgen#FABRK001-1) and then centrifuged at 10000×g for 1 minute to remove the supernatants. Subsequently, the RNA adsorbed on the Favorgen micro column was dissolved by 10 μl of an RNase-free water to obtain a solution containing RNA. This step was repeated twice. The solution containing RNA was collected and analyzed by Small RNA assay kit and Agilent 2100 Bioanalyzer.

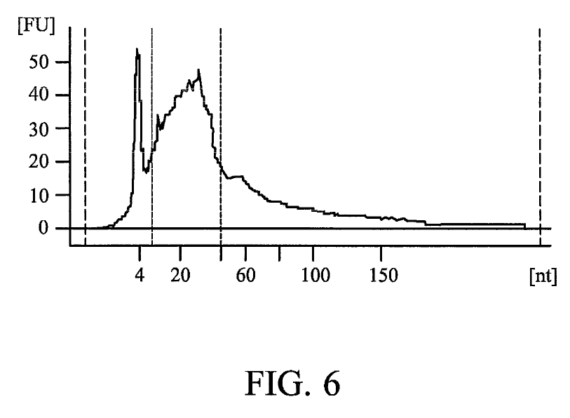

FIG. 6 illustrates the RNA fragment exceeding 50 nt was removed and the desired RNA fragments (miRNA), RNA fragments of 4-40 nt, were obtained as shown after separation.

### Example 5

### Separation of Oligonucleotides Using a Filter

Two tubes of 8% polyacrylamid gel column described in example 4 were prepared. The gel solution was loaded to the separation tube for 30-60 min until the gel was solidified. Before linked to the gel column, a Vivapure ion exchange column Q (Sartorius #VS-1X01QM24) and a column D (Sartorius #VS-1X01DM24) were washed two times by using 500 μl of ddH₂O. After standing for 5 minutes, the ddH₂O was removed by centrifugation of 2000×g for 30 seconds. After the polyacrylamide gel mixture was solidified, the Vivapure ion exchange column Q and the column D were fullfilled with 1× TBE buffer and respectively linked to one polyacrylamide gel.

A 30 μl of oligo mixture (3.3 μM of Cy5-labeled 20 nt oligonucleotide, 3.3 μM of Cy5-labeled 60 nt oligonucleotide, 0.001% Xylene cyanol dye, and 0.001% Bromophenol blue dye) was added to the polyacrylamid gel (electrophoresis gel) and then separated by the above electrophoresis apparatus and electrophoresis at 3 mA until most of the Xylene cyanol dye traveled to a line which has a distance of 3 cm from the bottom of the gel column.

After electrophoresis, the Vivapure ion exchange columns were detached from the gel columns and placed on a 2-ml centrifuge tube, respectively. 300 μl of ddH₂O was added to the Vivapure ion exchange column, and then centrifuged at 2000×g for 30 seconds. This step was repeated twice. The Vivapure ion exchange columns were placed on a new 2-ml centrifuge tube, respectively. 20 μl of an 20% SDS solution was added to the Vivapure ion exchange column, incubated for 3 min, and then centrifuged at 2000×g for 30 seconds to obtain a flow-through solution containing oligonucleotides. This step was repeated twice.

The flow-through solution containing RNA was mixed with 187 μl of 100% EtOH and 40 μl of FARB buffer. The mixture was added to a Favorgen micro column and centrifuged at 10000×g for 30 seconds. The Favorgen micro columns were washed two times with 500 μl of Wash 2 buffer (Favorgen#FABRK001-1) and then spin dried at 10000×g for 1 minute to remove the wash buffer. Subsequently, the oligonucleotide adsorbed on Favorgen micro columns was eluted by 10 μl of a 0.2% SDS solution to obtain an eluate containing oligonucleotide. This step was repeated twice. The eluate containing oligonucleotides was separated by a PAGE (15% Novex TBE-Urea Gel, invitrogen #EC68855BOX) electrophoresis at 180 V for 20 minutes.

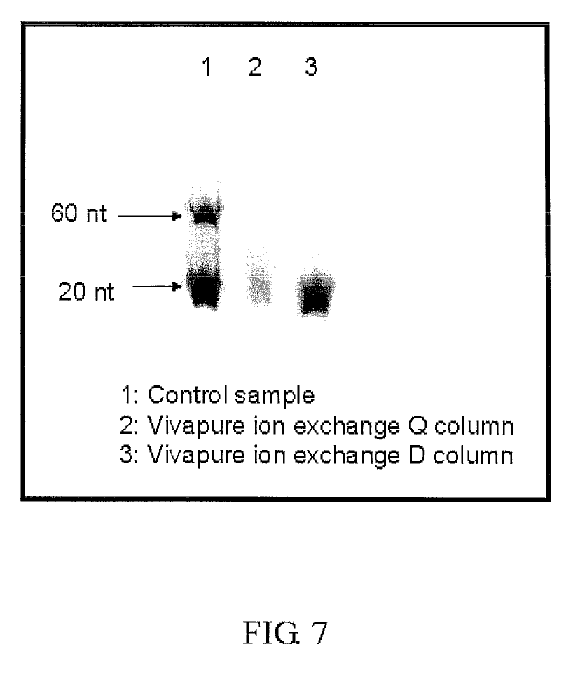

Referring to FIG. 7, after electrophoresis (lanes 2 and 3), only 20 nt oligonucleotide existed in the obtained eluate.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An electrophoresis apparatus for isolating or purifying bio-molecules comprising:
a separation tube comprising a first section for containing buffer and a second section including an electrophoresis gel, and
a collection tube comprising a solid phase, wherein the solid phase fully covers the cross-sectional area of the collection tube, and the collection tube is detachably connected to an end adjacent to the second section of the separation tube.

2. The electrophoresis apparatus in claim 1, wherein the bio-molecules comprise nucleic acids, DNA, RNA, protein, peptide, or a mixture thereof.

3. The electrophoresis apparatus in claim 1, wherein the bio-molecules are small nucleic acids, DNA, or RNA sample of 4-40 nucleotides.

4. The electrophoresis apparatus in claim 1, wherein the solid phase is a cationic solid phase.

5. The electrophoresis apparatus in claim 4, wherein the cationic solid phase comprises at least one bead, membrane, filter, or a mixture thereof.

6. The electrophoresis apparatus in claim 4, wherein the cationic solid phase comprises tertiary or quaternary amino groups.

7. The electrophoresis apparatus in claim 5, wherein the cationic solid phase comprises a filter having a pore size, wherein the water is extruded through the filter at a flow rate of between about 0.005 and about 1 mL/min/mm² under between 2000×g and 10000×g centrifugation.

8. The electrophoresis apparatus in claim 5, wherein the cationic solid phase comprises a filter having a pore size, wherein the water is extruded through the filter at a flow rate of between about 0.0177 and about 0.15 mL/min/mm² under between 2000×g and 10000×g centrifugation.

9. The electrophoresis apparatus in claim 1, wherein the solid phase comprises quaternary amine agarose beads, tertiary amine cellulose beads, tertiary amine filter, or quaternary amine filter.

10. The electrophoresis apparatus in claim 1, wherein the separation tube has a diameter of 0.1 cm to 2 cm.

11. The electrophoresis apparatus in claim 1, wherein the electrophoresis gel has a length of 0.5 cm to 20 cm.

12. A method for purifying or isolating bio-molecules comprising:
providing the electrophoresis apparatus as claimed in claim 1;
loading a sample comprising at least one bio-molecule to the first section of the separation tube;
applying an electric field by implementing at least one anode and at least one cathode to drive the at least one bio-molecule into the solid phase, wherein the electrophoresis apparatus is located between the at least one anode and at least one cathode;
detaching the collection tube from the separation tube, and
purifying the at least one bio-molecule isolated in the collection tube.

13. The method in claim 12, wherein the solid phase is soaked in water or a buffer.

14. The method in claim 12, further comprising monitoring the location of the at least one bio-molecule during application of the electric field.

15. The method in claim 14, wherein the monitoring comprises detecting UV light illumination, fluorescence, or monitoring the location of an electrophoresis indicator.

16. The method in claim 12, wherein the at least one bio-molecule comprises DNA, RNA, protein, peptide, or a mixture thereof.

17. The method in claim 12, wherein the at least one bio-molecule is a small DNA or RNA sample of 4-40 nucleotides.

18. The method in claim 12, wherein the solid phase is a cationic solid phase.

19. The method in claim 18, wherein the cationic solid phase comprises at least one bead, membrane, filter, or a mixture thereof.

20. The method in claim 19, wherein the cationic solid phase comprises a filter having a pore size, wherein the water is extruded through said filter at a flow rate of between about 0.005 and about 1 mL/min/mm² under between 2000×g and 10000×g centrifugation.

21. The method in claim 19, wherein the cationic solid phase comprises a filter having a pore size, wherein the water is extruded through said filter at a flow rate of between about 0.0177 and about 0.15 mL/min/mm² under between 2000×g and 10000×g centrifugation.

22. The method in claim 18, wherein the cationic solid phase comprises tertiary or quaternary amino groups.

23. The method in claim 12, wherein the solid phase comprises quaternary amine agarose beads, tertiary amine cellulose beads, tertiary amine filter, or quaternary amine filter.

24. The method in claim 12, further comprising replacing a new collection tube with the collection tube to separately collect different bio-molecules.

25. A kit for isolating or purifying bio-molecules, comprising:
the electrophoresis apparatus as claimed in claim 1;
a running buffer;
at least one elution or purification buffer, and
an user instruction.
